(19) United States
(12) Patent Application Publication
(10) Pub. No.: US 2019/0190969 A1
(43) Pub. Date: Jun. 20, 2019

(54) SYSTEMS AND METHODS FOR SHARING CONTENT

(71) Applicant: Facebook, Inc., Menlo Park, CA (US)

(72) Inventor: Alex Douglas Cornell, San Francisco, CA (US)

(21) Appl. No.: 15/845,081

(22) Filed: Dec. 18, 2017

(51) Int. Cl. H04L 29/06; H04L 12/58; G06Q 50/00; G06F 3/0488; H04N 1/00

(52) U.S. Cl. CPC H04L 65/4076; H04L 51/32; H04N 1/00204; H04L 65/604; G06F 3/0488; G06Q 50/01

(57) ABSTRACT

Systems, methods, and non-transitory computer-readable media can provide an interface that includes a plurality of panes. A determination can be made that a first pane is being accessed, the first pane for capturing and broadcasting live content through a social networking system. A live content stream can be captured upon accessing the first pane. Data corresponding to the live content stream can be provided to the social networking system for broadcasting.

### FIELD OF THE INVENTION

The present technology relates to the field of content provisioning over a computer network. More particularly, the present technology relates to techniques for broadcasting content through a social networking system.

### BACKGROUND

Users often utilize computing devices (or systems) for a wide variety of purposes. Users can use their computing devices to, for example, interact with one another, access content, share content, and create content. In some cases, content can be provided by members of a social networking system. The content can include one or a combination of text, images, videos, and audio. The content may be published to the social networking system for consumption by others.

### SUMMARY

Various embodiments of the present disclosure can include systems, methods, and non-transitory computer readable media configured to provide an interface that includes a plurality of panes. A determination can be made that a first pane is being accessed, the first pane for capturing and broadcasting live content through a social networking system. A live content stream can be captured upon accessing the first pane. Data corresponding to the live content stream can be provided to the social networking system for broadcasting.

In some embodiments, the interface includes a second pane for accessing a content library, and the interface includes a third pane for accessing other live content stream being broadcasted through the social networking system.

In some embodiments, the live content stream ceases to be accessible through the social networking system once broadcasting ends.

In some embodiments, broadcasting of the live content stream is paused when the second pane or the third pane is accessed.

In some embodiments, the first pane includes at least one of an option to capture one or more screenshot images of the live content stream or an option to capture one or more videos of the live content stream.

In some embodiments, captured screenshot images or captured videos of the live content stream are stored on the computing device.

In some embodiments, captured screenshot images or captured videos of the live content stream are stored in the content library accessible through the second pane.

In some embodiments, the second pane includes an option for sharing content stored in the content library through the social networking system.

In some embodiments, feedback received for the live content stream from other viewing users of the social networking system is provided through the first pane.

In some embodiments, an avatar associated with a viewing user animates when the viewing user interacts with the live content stream.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module, according to an embodiment of the present disclosure.

FIG. 2 illustrates an example of a live app module, according to an embodiment of the present disclosure.

FIG. 3 illustrates an example diagram, according to an embodiment of the present disclosure.

FIGS. 4A-4B also illustrate example diagrams, according to an embodiment of the present disclosure.

FIG. 5 illustrates an example method, according to an embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Sharing Content

As mentioned, users often utilize computing devices for a wide variety of purposes. Users can use their computing devices to, for example, interact with one another, access content, share content, and create content. In some cases, content items can include postings from users of an online community or platform, such as a social networking system. The postings may include one or a combination of text, images, videos, and audio. The postings may be published through the social networking system for consumption by others. Under conventional approaches, content items posted by a user can be included in one or more content feeds that are accessible through the social networking system. In general, content posted by users tend to reflect past events that have already occurred in time. As such, the posted content can be static, old, stale, and lack spontaneity. Even when conventional approaches allow for the capture and live broadcast of content (e.g., live video), these approaches can require extensive user interactions with electronic devices or other equipment to initiate and maintain the live broadcast. The extent of such user interactions and resulting delay often hinder timely capture of spontaneous events. Further, conventional techniques for supporting a live broadcast through an electronic device can undesirably preclude separate, simultaneous capture of images or video segments through the same electronic device.

An improved approach rooted in computer technology overcomes the foregoing and other disadvantages associated with conventional approaches specifically arising in the realm of computer technology. Based on computer technology, content can be shared in real-time with users of a content provider (e.g., social networking system). Such content may include live content that is being broadcasted through the content provider. For example, such live content (or live content item) can correspond to content that is being captured and streamed live by a user (e.g., a broadcaster). In this instance, the broadcaster can capture and stream an event (e.g., a live video of the broadcaster, a hiking scenery, a vacation trip, etc.) as part of a live content stream. Such events can be captured using computing devices (e.g., mobile devices with audio and video capture capabilities) and/or standalone devices (e.g., video cameras and microphones). A user (e.g., a viewer) operating a computing device can access the live content stream through the content provider. In response, the content provider encodes and provides data corresponding to the live content stream to the user's computing device over a network (e.g., the Internet) in real-time (or near real-time). The computing device can decode and present the live content stream, for example, through a display screen of the computing device. In general, the live content stream continues to be provided to the user's computing device until the broadcaster stops streaming live content or the user instructs the computing device to stop accessing the live content stream. In various embodiments, a standalone software application (“live app”) can be used to capture and stream live content through the content provider. For example, a user operating a computing device can launch the live app. When launched, the live app can instruct the computing device to immediately begin capturing and streaming live content through the content provider without additional input from the user. More details relating to the disclosed technology are provided below.

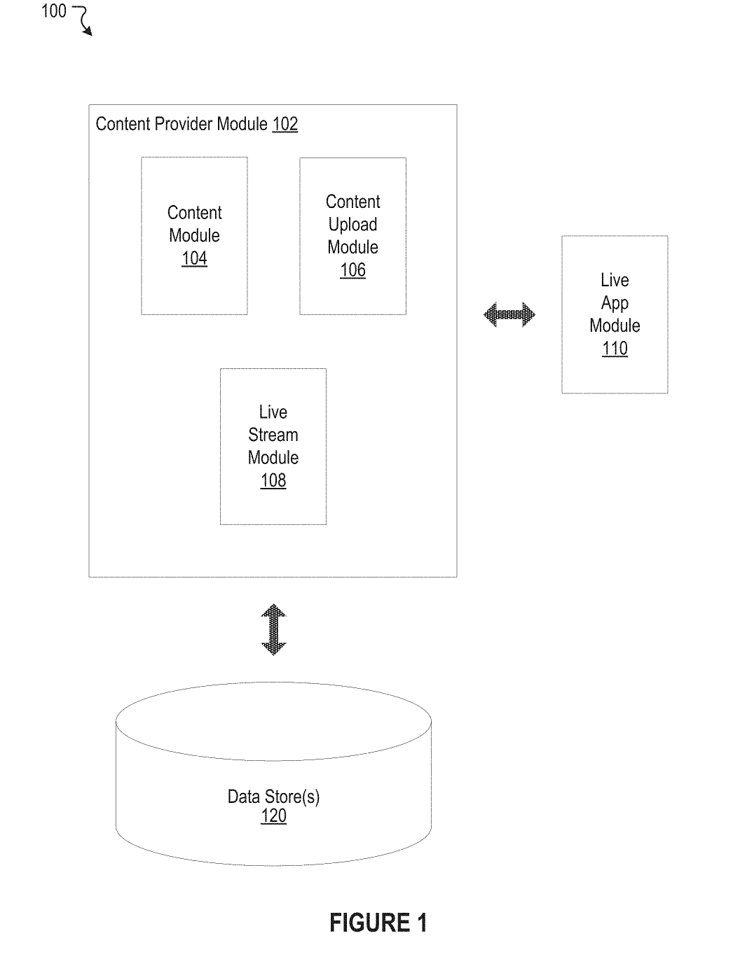

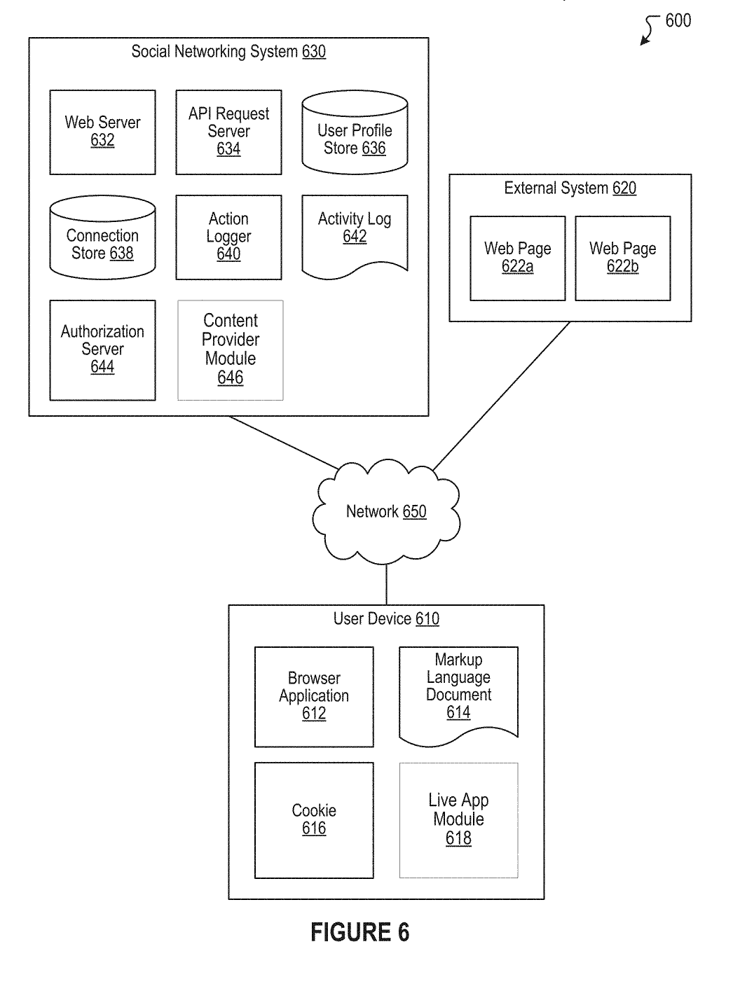

FIG. 1 illustrates an example system 100 including an example content provider module 102, according to an embodiment of the present disclosure. As shown in the example of FIG. 1, the content provider module 102 can include a content module 104, a content upload module 106, and a live stream module 108. In some instances, the example system 100 can include at least one data store 120. A live app module 110 can interact with the content provider module 102 over one or more networks (e.g., the Internet, a local area network, a cellular network, etc.). In some embodiments, the live app module 110 can be implemented as a standalone software application (“live app”) running on a computing device being operated by a user. In some embodiments, the user is a member of a social network (e.g., the social networking system 630 of FIG. 6). The components (e.g., modules, elements, etc.) shown in this figure and all figures herein are exemplary only, and other implementations may include additional, fewer, integrated, or different components. Some components may not be shown so as not to obscure relevant details.

In some embodiments, the content provider module 102 and/or the live app module 110 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 or at least a portion thereof can be implemented using one or more computing devices or systems that include one or more servers, such as network servers or cloud servers. In some instances, the content provider module 102 and/or the live app module 110 can, in part or in whole, be implemented within or configured to operate in conjunction with a social networking system (or service), such as the social networking system 630 of FIG. 6. In some instances, the content provider module 102 and/or the live app module 110 can be, in part or in whole, implemented within or configured to operate in conjunction or be integrated with a client computing device, such as the user device 610 of FIG. 6. For example, the content provider module 102 and/or the live app module 110 can be implemented as or within a dedicated application (e.g., app), a program, or an applet running on a user computing device or client computing system. The application incorporating or implementing instructions for performing some, or all, functionality of the content provider module 102 and/or the live app module 110 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The content provider module 102 can be configured to communicate and/or operate with the at least one data store 120, as shown in the example system 100. The at least one data store 120 can be configured to store and maintain various types of data. For example, the data store 120 can store information describing various content that has been posted by users of a social networking system. In some implementations, the at least one data store 120 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 120 can store information associated with users, such as user identifiers, user information, profile information, user specified settings, content produced or posted by users, and various other types of user data.

The content provider module 102 can be configured to provide users with access to content items that are posted, or made available, through a content provider (e.g., social networking system). For example, a user can interact with an interface that is provided by a software application (e.g., a social networking application) running on a computing device of the user. This interface can be used to access various content items that are accessible through the social networking system. In some instances, the content module 104 can include various content items in the user's news feed. Such content items may include on-demand content items as well as content that is being streamed live. The user can access content items while browsing the news feed. In some instances, the content module 104 can also identify and provide content items that are responsive to search queries submitted through the interface.

In some embodiments, this interface can include an option for posting, or uploading, content items to the social networking system. When posting a content item, the content upload module 106 can be utilized to communicate data corresponding to the content item from the computing device to the social networking system. Such content items may include text, images, audio, and videos, for example. The social networking system can then provide the content item through the social networking system including, for example, in one or more news feeds.

In some embodiments, the live stream module 108 can be configured to receive and distribute live content streams through the social networking system. When a live content stream is initiated by a computing device, the live stream module 108 can be utilized to communicate data (e.g., audio data, video data, etc.) corresponding to the content to be streamed live from the computing device and through the social networking system. The live stream module 108 can utilize any generally known techniques that allow for live streaming of content including, for example, the Real Time Messaging Protocol (RTMP). In various embodiments, the computing device from which the live content stream is being provided can be equipped to capture data (e.g., video data, audio data, etc.) corresponding to the live content stream.

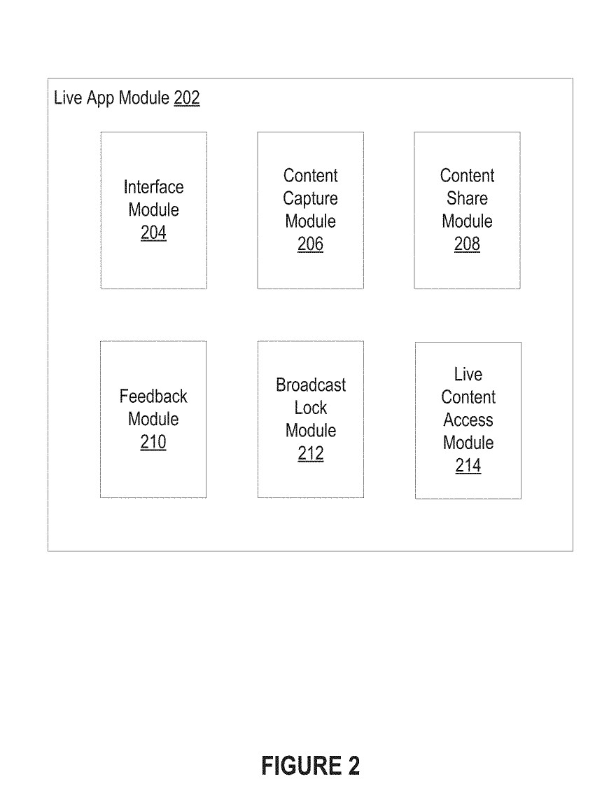

In various embodiments, the live app module 110 can be configured to capture and provide content to be streamed live through the content provider module 102. As mentioned, in some embodiments, the live app module 110 can be implemented as a standalone software application (“live app”) that can run on various computing devices. In some embodiments, a user operating a computing device can launch the software application in which the live app module 110 is implemented to immediately begin capturing live content. For example, in some embodiments, the live app module 110 can instruct the computing device to begin capturing data (e.g., video data, audio data, etc.) corresponding to a live content stream without additional input from the user. In this example, the live app module 110 can communicate the captured data to the live stream module 108 for distribution through the social networking system, as described above. More details regarding the live app module 110 will be provided below with reference to FIG. 2.

FIG. 2 illustrates an example of a live app module 202, according to an embodiment of the present disclosure. In some embodiments, the live app module 110 of FIG. 1 can be implemented as the live app module 202. As shown in FIG. 2, the live app module 202 can include an interface module 204, a content capture module 206, a content share module 208, a feedback module 210, a broadcast lock module 212, and a live content access module 214. In some embodiments, the live app module 202 can be implemented in a software application, such as a “live app,” running on a computing device being operated by a user.

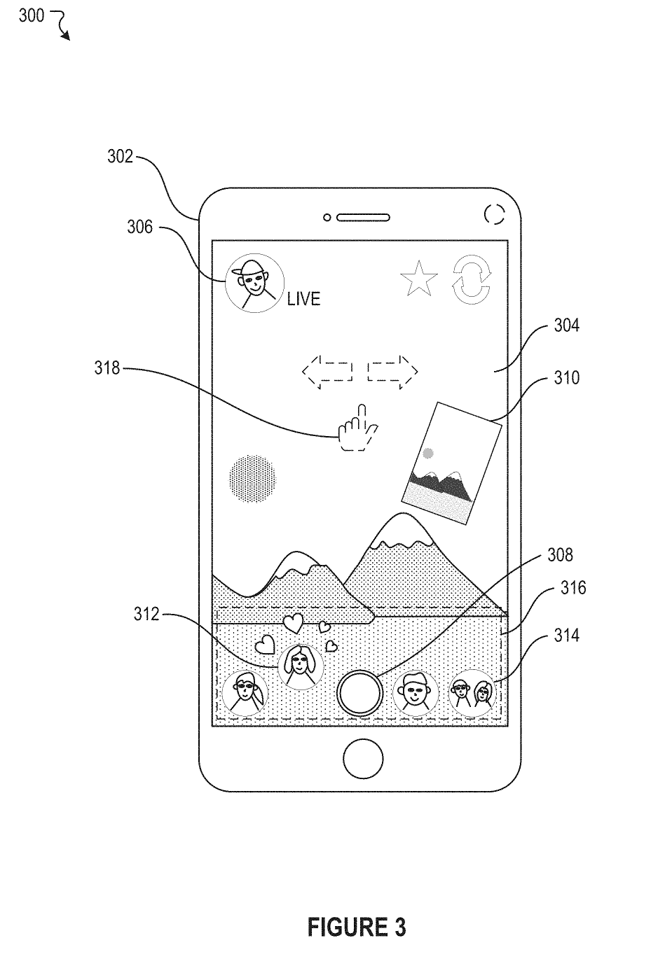

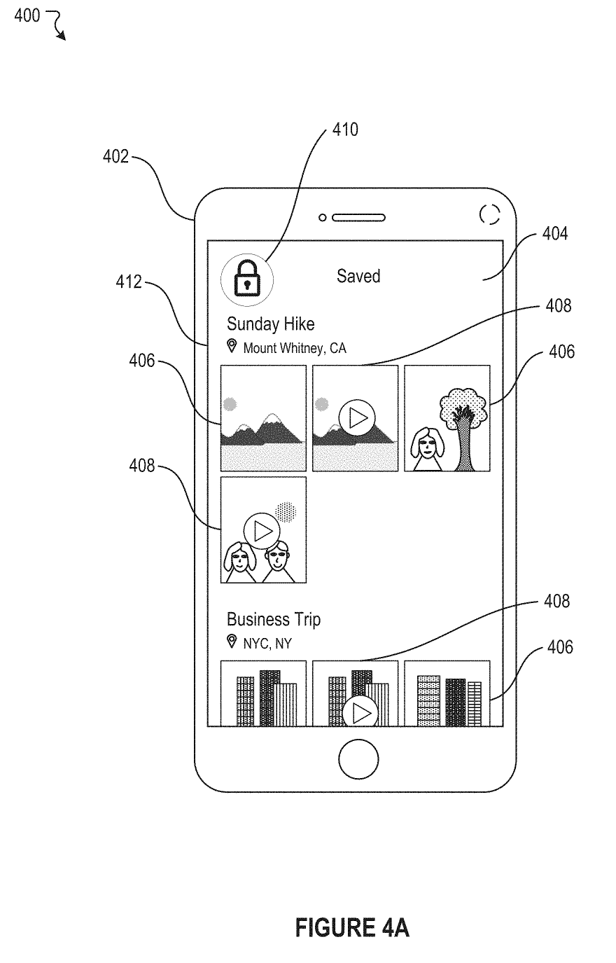

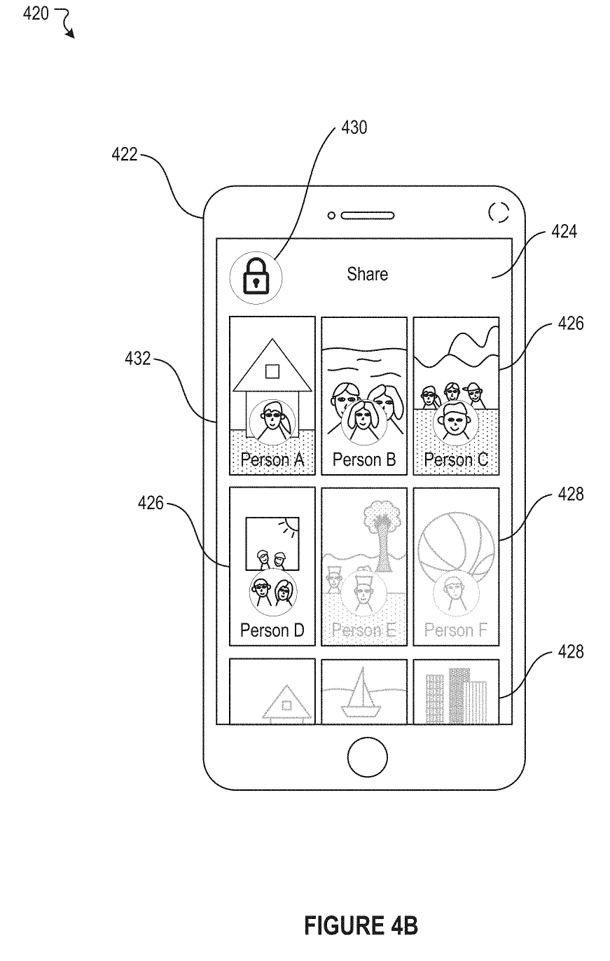

The interface module 204 can be configured to provide an interface having one or more panes that are accessible through the live app running on a computing device, as illustrated in the examples of FIG. 3 and FIGS. 4A-4B. As used herein, a pane can be a user interface or portion thereof, such as a screen, a space, a surface, or the like. For example, in some embodiments, the interface module 204 can provide a first pane through which live content streams can be captured and broadcasted through the social networking system. In some embodiments, the interface module 204 can provide a second pane through which content that is stored on (or is otherwise accessible to) the computing device can be accessed. In some embodiments, the interface module 204 can provide a third pane through which live content streams being broadcasted by other users of the social networking system can be accessed. Many variations are possible.

In various embodiments, the content capture module 206 can be configured to capture various types of content. For example, in some embodiments, the content capture module 206 can be configured to capture data (e.g., video data, audio data, etc.) corresponding to live content streams. In some embodiments, when a user (e.g., a broadcaster) launches the live app on a computing device, the content capture module 206 can automatically begin capturing and communicating a live content stream of some event to the social networking system without additional input or commands provided by the user. In some embodiments, in addition to being accessible through the live app as discussed in more detail herein, the live content stream is made available as an ephemeral story that is accessible through the social networking system. In such embodiments, the live content stream can be accessible through a story on the social networking system provided the live content stream is active. That is, the live content stream continues to be accessible through the story on social networking system until broadcasting of the live content stream has ceased.

In some embodiments, the user operating the computing device can select options to capture and store portions of the live content stream. For example, in some embodiments, the user can select an option to capture a video of some, or all, of the live content stream being broadcasted. In such embodiments, the video can be stored on a data store associated with the computing device (e.g., a local data store, network-based data store, cloud-based data store, etc.). Similarly, in some embodiments, the user can select an option to capture one or more images (or screenshots) of the live content stream being broadcasted. In such embodiments, the captured images can also be stored on the data store associated with the computing device. In some embodiments, captured live content stream can be made accessible as a story. In such embodiments, the captured live content stream remains accessible as a story through the social networking system for a pre-defined time period (e.g., 24 hours).

In various embodiments, the content share module 208 can be configured to share captured content. For example, the captured content may be shared with other users of the social networking system. In various embodiments, the captured content can include screenshot images or videos of any live content streams that are actively being broadcasted or were previously broadcasted through the social networking system. In some embodiments, such content may be shared with other users in one or more messages sent through the social networking system and/or in one or more content feeds that are accessible through the social networking system, for example.

The feedback module 210 can be configured to convey interactions (e.g., likes, reactions, etc.) received from users accessing a live content stream being broadcasted through the social networking system. For example, the computing device running the live app can broadcast a live content stream through the social networking system. During the broadcast, the feedback module 210 can determine when a viewer of the live content stream has selected options to interact with the live content stream. Such options can include an option to “like” the live content stream or options to react to the live content stream (e.g., a “happy” reaction, a “sad” reaction, etc.), for example. When the viewer selects an option to interact with the live content stream, the feedback module 210 can indicate such interaction, for example, through the interface provided by the interface module 204. In some embodiments, viewers of the live content stream can be represented in the interface as avatars. In some embodiments, an avatar corresponding to a viewer can animate when that viewer interacts with the live content stream. For example, the viewer may send feedback, such as a “love” reaction while accessing the live content stream. In this example, the feedback module 210 can cause an avatar associated with the viewer to reflect the interaction through the interface using some pre-defined animation. Many variations are possible.

In various embodiments, the broadcast lock module 212 can be configured to pause broadcasting of a live content stream. For example, in some embodiments, when launched, the live app can provide a pane associated with a camera view through which live content can be captured and broadcasted. In some instances, a user may access other panes provided by the live app while live content is actively being captured and broadcasted. For example, the user may access another pane that provides access to a content library. In another example, the user may access a different pane that provides access to other live content streams that are available to view. In some embodiments, the broadcast lock module 212 can pause broadcasting of the live content when a pane other than the pane associated with the camera view is accessed during the broadcast. In some embodiments, the broadcast lock module 212 can indicate when a live content broadcast is paused using some visual indicator (e.g., broadcast lock icon, overlay, etc.). In some embodiments, the broadcasting of the live content can resume when the pane associated with the camera view is again accessed in the live app.

In various embodiments, the live content access module 214 can provide access to other live content streams that are being broadcasted through the social networking system. For example, in some embodiments, the live content access module 214 can provide access to live content streams through a different pane of the live app. In such embodiments, live content streams can be selected and viewed in the different pane of the live app.

FIG. 3 illustrates an example diagram 300, according to an embodiment of the present disclosure. In the example of FIG. 3, a user operating a computing device 302 has launched an instance of the live app that proceeds to broadcast a live event through a social networking system without further user inputs or commands apart from the launch of the instance of the live app. In some embodiments, when the live app is first launched, the live app defaults to a first pane 304. The first pane 304 can be associated with a camera view through which content captured and streamed through the social networking system is presented. In some embodiments, the first pane 304 can include a live status indicator 306 that indicates whether the computing device 302 is actively broadcasting live content through the social networking system. The first pane 304 can also include a region 316 in which avatars 314 corresponding to users (or viewers) accessing the live content stream can be displayed. In some embodiments, an avatar associated with a viewer can animate when that viewer interacts with the live content stream through the social networking system. For example, the viewer may select an option to submit a “love” reaction. In this example, the social networking system can instruct the live app to animate the avatar associated with the viewer. Here, the avatar is shown animating as exploding hearts 312. In some embodiments, the first pane 304 includes an option 308 for capturing the live content stream being broadcasted. For example, in some embodiments, the option 308 can be selected (e.g., held, double tapped, etc.) to capture a video of some, or all, of the live content stream. In some embodiments, the option 308 can be selected (e.g., tapped, etc.) to capture one or more screenshots 310 (or images) of the live content stream. In some embodiments, captured content can be stored in a local data store of the computing device 302. In some embodiments, captured content can be accessible to users of the social networking system through a story feed. In some embodiments, the user can use one or more touch screen gestures 318 to access different panes within the live app. For example, in some embodiments, a swipe gesture (e.g., a left swipe) can be used to access a second pane that is accessible through the live app. In some embodiments, a different swipe gesture (e.g., a right swipe) can be used to access a third pane that is accessible through the live app. Many variations are possible.

FIG. 4A illustrates an example diagram 400, according to an embodiment of the present disclosure. In the example of FIG. 4A, a user operating a computing device 402 has launched an instance of the live app and is accessing a second pane 404 of the live app. The user can access the second pane 404 by performing a touch screen gesture on a display screen 412 of the computing device 402. For example, the second pane 404 may be accessed by performing a swipe gesture from a first pane of the live app (e.g., the first pane 304 of FIG. 3). In some embodiments, the second pane 404 can provide access to a content library associated with the computing device 402. The content library may include various content items that are accessible through one or more data stores (e.g., local data store, network-based data store, cloud-based data store, etc.) that are accessible to the computing device 402. In the example of FIG. 4A, the content library includes a number of screenshots (or images) 406 and videos 408 including content that was captured during a live broadcast. In some embodiments, the second pane 404 can include a lock indicator 410 that indicates the computing device 402 is not actively broadcasting live content through the social networking system. In this instance, the live broadcast is paused or stopped as long as the second pane 404 is being accessed. In some embodiments, the second pane 404 can include an option that enables the user to post (re-post) captured content to a social networking system.

FIG. 4B illustrates an example diagram 420, according to an embodiment of the current disclosure. In the example of FIG. 4B, a user operating a computing device 422 has launched an instance of the live app and is accessing a third pane 424 of the live app. The user can access the third pane 424 by performing a touch screen gesture through a display screen 432 of the computing device 422. For example, the third pane 424 may be accessed by performing a swipe gesture from a first pane of the live app (e.g., the first pane 304 of FIG. 3). In some embodiments, the third pane 424 can provide access to various live content steams that are being broadcasted through a social networking system. The live content streams can be arranged by their broadcast status. For example, active live content streams 426 (live content streams currently broadcasting) can be shown before inactive live content streams 428 (live content streams not currently broadcasting). In some embodiments, the user operating the computing device 422 can select (or tap) an active live content stream 426 to view (or access) live content corresponding the active live content stream through the computing device 422. Similar to the second pane 404 of FIG. 4A, in some embodiments, the third pane 424 can include a lock indicator 430 that indicates the computing device 422 is not actively broadcasting live content through the social networking system. In this instance, the live broadcast is paused or stopped while the third pane 424 is being accessed.

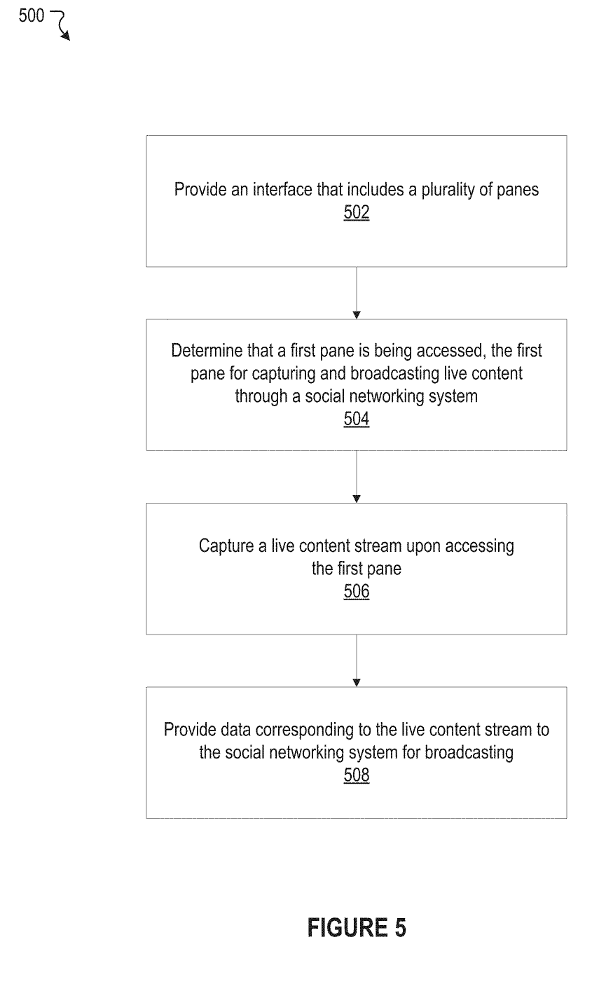

FIG. 5 illustrates an example method 500, according to various embodiments of the present disclosure. It should be appreciated that there can be additional, fewer, or alternative steps performed in similar or alternative orders, or in parallel, within the scope of various embodiments discussed herein unless otherwise stated.

At block 502, the example method 500 provides an interface that includes at least a plurality of panes. At block 504, the example method 500 determines that a first pane is being accessed, the first pane for capturing and broadcasting live content through a social networking system. At block 506, the example method 500 captures live content stream upon accessing the first pane. At block 508, the example method 500 provides data corresponding to the live content stream to the social networking system for broadcasting.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can be implemented with the content provider module 102, as discussed in more detail herein. In some embodiments, one or more functionalities of the content provider module 646 can also be implemented in the user device 610.

In some embodiments, the user device 610 can include a live app module 618. The live app module 618 can be implemented with the live app module 110 of FIG. 1. In some embodiments, one or more functionalities of the live app module 618 can also be implemented in the social networking system 630. In some embodiments, the social networking system 630 can include a content provider module 646. The content provider module 646 can be implemented with the content provider module 102 of FIG. 1.

### Hardware Implementation

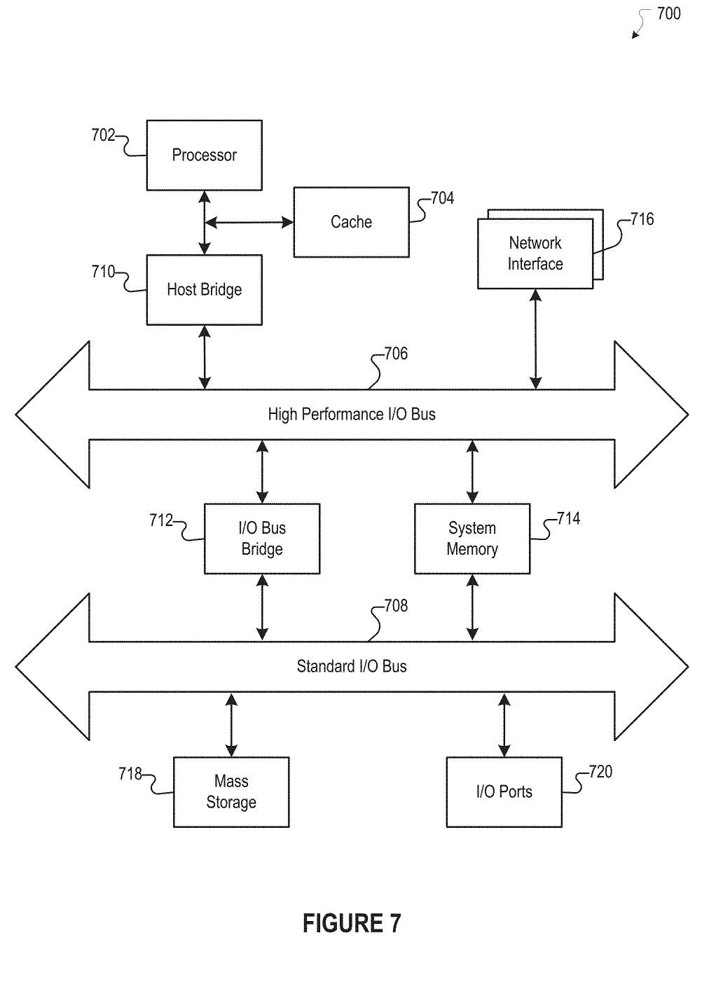

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing, by a computing device, an interface that includes a plurality of panes;
determining, by the computing device, that a first pane is being accessed, the first pane for capturing and broadcasting live content through a social networking system; and
capturing, by the computing device, a live content stream upon accessing the first pane; and
providing, by the computing device, data corresponding to the live content stream to the social networking system for broadcasting.

2. The computer-implemented method of claim 1, wherein:
the interface includes a second pane for accessing a content library; and
the interface includes a third pane for accessing other live content streams being broadcasted through the social networking system.

3. The computer-implemented method of claim 1, wherein the live content stream ceases to be accessible through the social networking system once broadcasting ends.

4. The computer-implemented method of claim 1, wherein broadcasting of the live content stream is paused when the second pane or the third pane is accessed.

5. The computer-implemented method of claim 1, wherein the first pane includes at least one of an option to capture one or more screenshot images of the live content stream or an option to capture one or more videos of the live content stream.

6. The computer-implemented method of claim 5, wherein captured screenshot images or captured videos of the live content stream are stored on the computing device.

7. The computer-implemented method of claim 5, wherein captured screenshot images or captured videos of the live content stream are stored in a content library accessible through a second pane.

8. The computer-implemented method of claim 7, wherein the second pane includes an option for sharing content stored in the content library through the social networking system.

9. The computer-implemented method of claim 1, wherein feedback received for the live content stream from other viewing users of the social networking system is provided through the first pane.

10. The computer-implemented method of claim 9, wherein an avatar associated with a viewing user animates when the viewing user interacts with the live content stream.

11. A system comprising:
at least one processor; and
a memory storing instructions that, when executed by the at least one processor, cause the system to perform:
providing an interface that includes a plurality of panes;
determining that a first pane is being accessed, the first pane for capturing and broadcasting live content through a social networking system;
capturing a live content stream upon accessing the first pane; and
providing data corresponding to the live content stream to the social networking system for broadcasting.

12. The system of claim 11, wherein:
the interface includes a second pane for accessing a content library; and
the interface includes a third pane for accessing other live content streams being broadcasted through the social networking system.

13. The system of claim 11, wherein the live content stream ceases to be accessible through the social networking system once broadcasting ends.

14. The system of claim 11, wherein broadcasting of the live content stream is paused when the second pane or the third pane is accessed.

15. The system of claim 11, wherein the first pane includes at least one of an option to capture one or more screenshot images of the live content stream or an option to capture one or more videos of the live content stream.

16. A non-transitory computer-readable storage medium including instructions that, when executed by at least one processor of a computing system, cause the computing system to perform a method comprising:
providing an interface that includes a plurality of panes;
determining that a first pane is being accessed;
capturing a live content stream upon accessing the first pane, the first pane for capturing and broadcasting live content through a social networking system; and
providing data corresponding to the live content stream to the social networking system for broadcasting.

17. The non-transitory computer-readable storage medium of claim 16, wherein:
the interface includes a second pane for accessing a content library; and
the interface includes a third pane for accessing other live content streams being broadcasted through the social networking system.

18. The non-transitory computer-readable storage medium of claim 16, wherein the live content stream ceases to be accessible through the social networking system once broadcasting ends.

19. The non-transitory computer-readable storage medium of claim 16, wherein broadcasting of the live content stream is paused when the second pane or the third pane is accessed.

20. The non-transitory computer-readable storage medium of claim 16, wherein the first pane includes at least one of an option to capture one or more screenshot images of the live content stream or an option to capture one or more videos of the live content stream.
